(19) United States
(12) Patent Application Publication
(10) Pub. No.: US 2010/0137519 A1
(43) Pub. Date: Jun. 3, 2010

(54) Process for the Preparation of a Vulcanized Blend of Rubbers

(76) Inventors: Jacobus Wilhelmus Maria J.W.M. Noordermeer, Nieuwstadt (NL); Nityananda L. Naskar, Parganas (IN); Rabindra Nath R.N. Datta, Schalkhaar (NL)

Correspondence Address: NIXON & VANDERHYE, PC, 901 NORTH GLEBE ROAD, 11TH FLOOR, ARLINGTON, VA, 22203, US

(21) Appl. No.: 11/884,347

(22) PCT Filed: Feb. 21, 2006
(86) PCT No.: PCT/NL06/00090

§ 371 Date: Jan. 25, 2008

(30) Foreign Application Priority Data
Feb. 22, 2005 (NL) PCT/NL2005/000130
Oct. 5, 2005 (NL) PCT/NL2005/000715

(51) Int. Cl. C08L 9/00

(52) U.S. Cl. 525/235; 525/236; 525/237

(57) ABSTRACT

This invention relates to a process for preparing a vulcanized rubber blend, said blend comprising (a) natural rubber or poly-isoprene rubber, (b) butadiene based rubber, and (c) rubber with an essentially saturated backbone. The improvement is that rubber c) is pre-heated with at least part of the vulcanization system before mixing with rubbers a) and b) and co-vulcanizing.

This invention relates to a process for the preparation of a vulcanized blend of rubbers, said blend comprising a) 0 to 100 parts by weight of either natural rubber or poly-isoprene rubber, b) 100 to 0 parts by weight of a butadiene based rubber, and c) 0.5 to 50 parts by weight of a rubber with an essentially saturated backbone, under the influence of a sulfur vulcanization system. This invention furthermore relates to a blend of rubbers, a vulcanized blend of rubbers, and a tire comprising a vulcanized blend of rubbers.

Quite often a blend of a natural rubber and a butadiene based rubber is used for tire compounds. Generally, in particular for tire sidewall compounds, chemical antioxidants and antiozonants are added to this blend to impart resistance to ozone, flex-fatigue and thermo-oxidative aging. Using conventional antioxidants and antiozonants to overcome these problems however results in quite some undesirable effects. First of all, as antiozonants react with ozone, the concentration of antiozonants in the compound reduces in time. Furthermore, curb scuffing and washing add to the depletion of the antiozonants in the compound. A second disadvantage of the antiozonants is that a lot of them are staining, or discoloring. From an esthetic point of view, especially for tires used for passenger vehicles, this is highly undesirable. A third disadvantage is that most of the antioxidants are toxic and should better not end up in the environment.

A prevalent solution to this problem is to add an inherently ozone resistant, saturated backbone rubber to the blend of the natural rubber and the butadiene based rubber. A process wherein an inherently ozone-resistant, saturated-backbone polymer is blended with a diene rubber is known from Waddell, W. H. (1998); Tire black sidewall surface discoloration and non-staining technology: a review; Rubber Chem. & Techn., volume 71, page 590-618. Rubbers such as ethylene-propylene-diene terpolymers (EPDM) have been extensively tested and used in conjunction with natural rubber and/or butadiene based rubbers.

The problem in such a process is the cure rate incompatibility of said blends of rubbers due to the difference in the saturation level of the rubbers. The one rubber has a much faster cure rate than the other, as a result of which depletion of curatives will occur for the rubbers with a faster cure rate. In the course of the vulcanization of such a blend said depletion forms a concentration gradient of the curative. This results in curative migration from the slower cure rate rubber to the faster cure rate rubber. Said migration of curatives even further aggravates the cure imbalance. A process like this results in a vulcanized blend of rubbers with under-cured rubber mixed with over-cured rubber.

The object of the present invention is a process wherein the problem of cure rate incompatibility is overcome to a great extent. This object is achieved by a process wherein rubber c) is pre-heated till close to scorch with at least a part of the sulfur vulcanization system, after which the resulting pre-vulcanized rubber c) is mixed with rubbers a) and/or b) and the remaining part of the sulfur vulcanization system, after which the resulting blend is co-vulcanized.

In the following the details of the ingredients and the process will be given. For a more detailed description of the commonly used ingredients and processes that are part of the present invention reference is made to W. Hofmann, “Rubber Technology Handbook”, chapter 4, rubber chemicals and additives, pp. 217-353, Hanser Publishers, Munich 1989.

### Rubber a)

Natural rubber (NR) is a natural homopolymer of isoprene. For the purpose of the present invention one can use for example SIR20, one of the major grades of Standard Indonesian Rubber, or any other Technically Specified Natural Rubber (TSR).

The natural rubber used in the present invention can also (at least in part) be replaced by synthetic poly-isoprene rubber. Poly-isoprene rubber has the same chemical structure as natural rubber and can therefore be used in the same type of applications as natural rubber.

### Rubber b)

A butadiene based rubber (BR) is a rubber based on polymerized butadiene. It has good elasticity, wear resistance and low temperature properties. Butadiene based rubbers suitable for the purpose of this invention are known in the rubber art.

For the present invention the proportion of the rubbers a) and b) can vary in between 0 (zero) parts by weight of either natural rubber or poly-isoprene rubber and 100 parts by weight of butadiene based rubber, to 100 parts by weight of either natural rubber or poly-isoprene rubber and 0 (zero) parts by weight of butadiene based rubber.

### Rubber c)

Essentially saturated backbone rubbers are known to be highly ozone resistant, and are therefore particularly suitable for the purpose of the present invention. To this category of essentially saturated backbone rubbers belong those rubbers that have a backbone with a saturation level of 90 to 100%. Rubbers of this kind are ethylene/α-olefin/diene terpolymer (EADM), brominated isobutylene-paramethylstyrene copolymer (BIMS), hydrogenated nitrile butadiene rubber (HNBR), and (halogenated) butyl rubbers. In the case of butyl rubbers generally 95 to 99% of the polymer backbone is saturated (isobutene based) and 1 to 5% unsaturated (isoprene based).

Preferably, rubber c) is an ethylene/α-olefin/diene copolymer. More preferably the α-olefin is propylene, or in other words, more preferably rubber c) is EPDM. The EADM used in the practice of the present invention refers to and includes copolymers formed by the interpolymerization of ethylene, an α-olefin and at least one other polyene monomer. Such polymers are well known to those skilled in the art and are typically prepared by using conventional Ziegler or metallocene polymerization techniques well known to those skilled in the art.

As will be appreciated by those skilled in the art, while propylene is a preferred monomer for copolymerization with ethylene and a diene monomer, it will be understood that in place of propylene, use can be made of other 1-alkenes containing 4 to 16 carbon atoms. The use of such higher α-olefins together with or in place of propylene are well known to those skilled in the art and include, particularly, 1-butene and 1-octene.

Use can be made of a variety of polyene monomers containing two or more carbon-to-carbon double bonds containing 4 to 20 carbon atoms, including non-cyclic polyene monomers, monocyclic polyene monomers and polycyclic polyene monomers. Representatives of such compounds include 1,4-hexadiene, dicyclopentadiene, bicyclo(2,2,1)hepta-2,5-diene (commonly known as norbornadiene), as well as the alkenyl norbornenes wherein the alkenyl group contains 1 to 20 carbon atoms and preferably 1 to 12 carbon atoms. Examples of some of the latter compounds include 5-methylene-2-norbornene, 5-ethylidene-2-norbornene, vinyl norbornene as well as alkyl norbornadienes. In a preferred embodiment of the rubber c) the diene is ethylidene norbornene.

Another preferred embodiment of rubber c) is a hydrogenated nitrile butadiene rubber (HNBR) having a backbone with a saturation level between 90 and 95%. In another preferred embodiment rubber c) comprises a (halogenated) butyl rubber or a (halogenated) isobutylene/para-alkylstyrene copolymer.

### Sulfur Vulcanization System

Similar to the state of the art, the sulfur vulcanization system used in the present invention generally comprises the following components: sulfur as vulcanization agent, an accelerator to activate the sulfur, and activators such as zinc oxide and stearic acid.

The amount of sulfur to be compounded with the rubber is preferably 0.1 to 25 parts per hundred rubber (phr) of sulfur and/or a sufficient amount of sulfur donor to provide the equivalent amount of sulfur, and more preferably 0.2 to 8 phr. These ingredients may be employed as a pre-mix, or added simultaneously or separately, and they may be added together with other rubber compounding ingredients as well.

In a preferred embodiment the sulfur vulcanization system comprises 0.1 to 8 phr of a vulcanization accelerator. More preferably, the sulfur vulcanization system comprises 0.3 to 4 phr of a vulcanization accelerator. Conventional, known vulcanization accelerators may be employed. Vulcanization accelerators include mercaptobenzothiazole, 2,2′-mercaptobenzothiazole, disulfide, sulfenamide accelerators including N-cyclohexyl-2-benzothiazole sulfenamide, N-tertiary-butyl-2-benzothiazole sulfenamide, N,NI-dicyclohexyl-2-benzothiazole sulfenamide and 2-(morpholinothio)benzothiazole; thiophosphoric acid derivative accelerators, thiurams, dithiocarbamates, diphenyl guanidine, diorthotolyl guanidine, dithiocarbamyl-sulfenamides, xanthates, triazine accelerators and mixtures thereof. Preferred accelerators are benzothiazole sulfenamide and benzothiazole sulfenimide.

Other conventional rubber additives may also be employed in amounts well known to those skilled in the art. For example, reinforcing agents such as carbon black, silica, clay, whiting and other mineral fillers, as well as mixtures of fillers, may be included in the rubber composition. Other additives such as process oils, tackifiers, waxes, antioxidants, antiozonants, pigments, resins, plasticizers, process aids, factice, compounding agents and activators such as stearic acid and zinc oxide may be included in conventional amounts. For a more complete listing of rubber additives which may be used in combination with the present invention reference is made to W. Hofmann, as cited before. Further, scorch retarders such as phtalic anhydride, pyromellitic anhydride, benzene hexacarboxylic trianhydride, 4-methylphtalic anhydride, trimellitic anhydride, 4-clorophthalic anhydride, N-cyclohexyl-thiophthalimide, salicyclic acid, benzoic acid, maleic anhydride and N-nitrosodiphenylamine may also be included in the rubber composition in conventional amounts. Finally, in specific applications it may also be desirable to include steel-cord adhesion promoters such as cobalt salts and dithiosulfates in conventional quantities.

### The Process

Rubber c) is first pre-heated before mixing it with rubbers a) and/or b) and subsequently co-vulcanizing the mixture of (the pre-heated) c) with a) and/or b). Pre-heating in this respect means initiating the curing process, while making sure that the rubber does not cure to the point that the rubber can not be processed anymore.

The pre-heating of rubber c) is executed as follows. Firstly, the rubber with an essentially saturated backbone (rubber c)) is mixed with at least part of the sulfur vulcanization system. Any mixer conventionally in use in the rubber industry can be used. Preferably rubber c) is mixed with the entire amount of the sulfur vulcanization system. It is preferred that the sulfur vulcanization system is present in an amount of between 1 and 15 wt. %, based on the total amount of rubbers.

Secondly, a sample of the mixture obtained from the first step is pre-heated in order to determine time (t), which is the time required for the commencement of cure. This time (t) is determined from the cure curve of the mixture as follows. Firstly, scorch time is determined (scorch time, referred to as ts2). Secondly, time (t) is fixed at a time close to scorch, approximately 95% of ts2.

Subsequently the mixture obtained from the first step is pre-heated for the predetermined time (t) at the chosen vulcanization temperature.

The third step is to mix this pre-heated mixture with the rubbers a) and/or b) and any remaining part of the sulfur vulcanization system, after which the resulting mixture is co-vulcanized. Preferably the rubbers a) and b) are pre-mixed before being used in this third step.

The rubber compounds resulting from the process according to the present invention show remarkably improved physical properties after full vulcanization. The elongation at break of the blends in which rubber c) was pre-vulcanized for example shows a two-fold improvement compared to blends with a non pre-vulcanized rubber c), whereas the tensile strength is improved as much as 3.5 times (see Table 3).

The present invention also relates to a blend of rubbers comprising (a) 0 to 100 parts by weight of either natural rubber or poly-isoprene rubber, (b) 100 to 0 parts by weight of a butadiene based rubber, and (c) 0.5 to 50 parts by weight of a sulfur pre-vulcanized rubber, said rubber having an essentially saturated backbone. Preferably, rubber c) is an ethylene/α-olefin/diene copolymer. More preferably the α-olefin is propylene, or in other words, more preferably rubber c) is EPDM. In a preferred embodiment of rubber c), the diene is ethylidene norbornene. Another preferred embodiment of rubber c) is a hydrogenated nitrile butadiene rubber (HNBR) having a backbone with a saturation level between 90 and 95%. In another preferred embodiment rubber c) comprises a (halogenated) butyl rubber or a (halogenated) isobutylene/para-alkylstyrene copolymer. Preferably, rubber c) is pre-vulcanized with a sulfur vulcanization system comprising an accelerator selected from a benzothiazole sulfenamide or a benzothiazole sulfenimide.

The present invention furthermore relates to a process for the co-vulcanization of a blend of rubbers as described above. The present invention also relates to a vulcanized blend of rubbers, resulting from the before mentioned co-vulcanization, as well as a tire comprising said vulcanized blend of rubbers. A vulcanized blend according to the present invention can be applied in any part of a tire, application in tire sidewalls being particularly suitable. Tires with a vulcanized blend according to the present invention can be prepared according to methods known in the rubber art.

The invention will be illustrated by the following Examples and comparative experiments, which are not meant to restrict the invention in whatever form.

### EXAMPLES I-V AND COMPARATIVE EXPERIMENTS A-J

In the following Examples and comparative experiments, rubber compounding (Table 2), vulcanization and testing (Table 3) was carried out according to standard methods except as otherwise stated. Base compounds were mixed in an internal batch mixer (Banbury mixer). Vulcanization ingredients and coagents were added to the compounds on a Schwabenthan Polymix 150 L two-roll mill (friction 1:1.22, temperature 700° C., 3 min.). Cure characteristics were determined using a Monsanto rubber processing Analyser RPA (arc 0.50): delta torque or extent of crosslinking (R∞) is the maximum torque (MH) minus the minimum torque (ML), optimum cure time (t90) is the time to 90% of delta torque above minimum. Sheets and test specimens were vulcanized by compression molding in a Fontyne TP-400 press. Tensile measurements were carried out using a Zwick 1445 tensile tester (ISO-2 dumbbells, tensile properties according to ASTM D 412-87).

### Examples I-V

The pre-heating of the rubber having an essentially saturated backbone (EPDM) was executed as follows. First the EPDM was mixed with the entire amount of the sulfur vulcanization system. This was executed in a Banbury mixer, with a starting temperature of 50° C. and a rotor speed of 100 rpm. The mixing sequence was as follows:

Time: 0 min, add EPDM (for Example V: also carbon black and naphthenic oil)
Time: 1 min, add activators (zinc oxide and stearic acid)
Time: 2 min, add TMQ (poly-2,2,4-trimethyl-1,2-dihydroquinoline)
Time: 4 min, add vulcanization system
Time: 5 min, dump at temperature 120-130° C.
The compound was sheeted out in a two-roll mill.

The compound was then pre-heated in a press at the chosen vulcanization temperature for the predetermined time (t) which is the time required for the commencement of cure (Table 1). This time, t which is very close to scorch time (ts2), was determined earlier from the cure curve of the compound.

TABLE 1
Pre-heating conditions.

| Example | I | II | III | IV | V |
|---|---|---|---|---|---|
| Vulcanization | 140 | 150 | 140 | 150 | 140 |
| temperature (° C.) | | | | | |
| Predetermined | 10 | 12 | 14.25 | 13 | 6.15 |
| time (t) (min.) | | | | | |

Finally this pre-heated EPDM compound was mixed with previously masticated NR and BR in a Banbury type mixer and co-vulcanized.

TABLE 2
Formulation of blends¹.

| Comparative | Exam- | NR² | BR² | EPDM² | CBS³ | DCBS³ | TBBS³ | TBSI³ | carbon | Naphthenic |
|---|---|---|---|---|---|---|---|---|---|---|
| experiment | ple | (phr) | (phr) | (phr) | (phr) | (phr) | (phr) | (phr) | black⁴ | oil⁵ |
| A | | 100 | — | — | 1.98 | — | — | — | | |
| B | | — | 100 | — | 1.98 | — | — | — | | |
| C | | — | — | 100 | 1.98 | — | — | — | | |
| D | | 50 | 50 | — | 1.98 | — | — | — | | |
| E | | 35 | 35 | 30 | 1.98 | — | — | — | | |
| | I | 35 | 35 | 30 | 1.98 | — | — | — | | |
| F | | 35 | 35 | 30 | — | 2.60 | — | — | | |
| | II | 35 | 35 | 30 | — | 2.60 | — | — | | |
| G | | 35 | 35 | 30 | — | — | 1.79 | — | | |
| | III | 35 | 35 | 30 | — | — | 1.79 | — | | |
| H | | 35 | 35 | 30 | — | — | — | 3.03 | | |
| | IV | 35 | | 30 | — | — | — | 3.03 | | |
| J | | 35 | 35 | 30 | 1.98 | | | | 50 | 10 |
| | V | 35 | 35 | 30 | 1.98 | | | | 50 | 10 |

¹All blends contained ZnO (4 phr), stearic acid (2 phr), TMQ (1 phr) and S (2.5 phr).
²the NR was SIR 20, the BR was Kosyn KBR 01 (cis-95%), and the EPDM was Keltan 578Z (ethylene 67%, ENB 4.5%)
³CBS = N-cyclohexyl-2-benzothiazole sulfenamide
DCBS = N,N-dicyclohexyl-2-benzothiazole sulfenamide
TBBS = N-t-butyl-2-benzothiazole sulfenamide
TBSI = N-t-butyl-2-benzothiazole sulfenimide
⁴the carbon black was high abrasion furnace black, HAF N330
⁵the naphthenic oil was Sunthene 4240

TABLE 3
Cure data and physical properties of vulcanizated blends cured at
160° C. of comparative experiments A-H and Examples I-IV.

| | | | Scorch | Optimum | | Tensile | | Mod. | |
|---|---|---|---|---|---|---|---|---|---|
| comparative | Exam- | Δtorque | time, | cure time | E-mod | strength | E.B. | 200% | Hardness |
| experiment | ple | R ∞ (dNm) | t2 (min) | t90 (min) | (N/mm²) | (Mpa) | (%) | (Mpa) | (shore A) |
| A | | 3.69 | 2.5 | 4.4 | 2.18 | 11.8 | 439 | 2.1 | 45 |
| B | | 4.91 | 3.8 | 15.1 | 2.14 | 1.1 | 86 | — | 51 |
| C | | 7.27 | 7.4 | 27.7 | 3.43 | 2.1 | 248 | 1.6 | 59 |
| D | | 4.30 | 3.7 | 7.8 | 1.66 | 2.4 | 249 | 1.9 | 49 |
| E | | 3.93 | 4.1 | 9.1 | 3.30 | 2.5 | 221 | 2.3 | 55 |
| | I | 3.89 | 0.6 | 1.9 | 2.48 | 9.5 | 476 | 2.1 | 53 |
| F | | 2.81 | 1.9 | 16.7 | 1.94 | 4.4 | 471 | 1.6 | 49 |
| | II | 3.06 | 1.7 | 10.4 | 2.45 | 12.1 | 651 | 1.6 | 48 |
| G | | 3.76 | 3.8 | 12.4 | 2.57 | 2.8 | 271 | 2.1 | 54 |
| | III | 3.81 | 1.2 | 4.0 | 2.03 | 10.6 | 512 | 2.0 | 52 |
| H | | 4.12 | 2.4 | 14.4 | 3.26 | 2.2 | 176 | — | 55 |
| | IV | 4.20 | 1.5 | 6.1 | 1.96 | 8.2 | 435 | 2.1 | 54 |

TABLE 4
Cure data and physical properties of comparative experiment I and Example V.

| | | | | | Tensile | | | |
|---|---|---|---|---|---|---|---|---|
| comparative | | Δtorque | Scorch time, t2 | Optimum cure | strength | E.B. | Mod. 100% | Mod. 300% |
| experiment | Example | R ∞ (dNm) | (min) | time t90 (min) | (Mpa) | (%) | (Mpa) | (Mpa) |
| J | | 9.28 | 3.03 | 18.82 | 13.2 | 332.5 | 3.5 | 12.0 |
| | V | 7.81 | 0.93 | 7.39 | 17.9 | 488.1 | 2.9 | 10.5 |

1. Process for the preparation of a vulcanized blend of rubbers, said blend comprising:
a) 0 to 100 parts by weight of either natural rubber or poly-isoprene rubber,
b) 100 to 0 parts by weight of a butadiene based rubber, and
c) 0.5 to 50 parts by weight of a rubber with an essentially saturated backbone,
under the influence of a sulfur vulcanization system, wherein rubber c) is pre-heated till close to scorch with at least a part of the sulfur vulcanization system, after which the resulting pre-vulcanized rubber c) is mixed with rubbers a) and/or b) and the remaining part of the sulfur vulcanization system, after which the resulting blend is co-vulcanized.

2. Process according to claim 1, wherein rubber c) is an ethylene/α-olefin/diene copolymer.

3. Process according to claim 2, wherein the α-olefin is propylene.

4. Process according to claim 2, wherein the diene is ethylidene norbornene.

5. Process according to claim 1, wherein rubber c) is hydrogenated nitrile butadiene rubber having a backbone with a saturation level between 90 and 95%.

6. Process according to claim 1, wherein rubber c) comprises a (halogenated) butyl rubber or a (halogenated) isobutylene/para-alkylstyrene copolymer.

7. Process according to claim 1, wherein the sulfur vulcanization system comprises 0.1 to 25 phr of sulfur and/or a sufficient amount of sulfur donor to provide the equivalent amount of sulfur.

8. Process according to claim 1, wherein the sulfur vulcanization system comprises 0.1 to 8 phr of a vulcanization accelerator.

9. Process according to claim 1, wherein the sulfur vulcanization system comprises an accelerator selected from a benzothiazole sulfenamide or a benzothiazole sulfenimide.

10. Process according to claim 1, wherein rubber c) is pre-heated with the entire amount of the sulfur vulcanization system.

11. Process according to claim 1, wherein the sulfur vulcanization system is present in an amount of between 1 and 15 wt. %, based on the total amount of rubbers.

12. Process according to claim 1, wherein rubbers a) and b) are pre-mixed.

13. Blend of rubbers, comprising:
a) 0 to 100 parts by weight of either natural rubber or poly-isoprene rubber,
b) 100 to 0 parts by weight of a butadiene based rubber, and
c) 0.5 to 50 parts by weight of a sulfur pre-vulcanized rubber, said rubber having an essentially saturated backbone, and said rubber being pre-vulcanized close to scorch.

14. Blend of rubbers according to claim 13, wherein rubber c) is an ethylene/α-olefin/diene copolymer.

15. Blend of rubbers according to claim 14, wherein the α-olefin is propylene.

16. Blend of rubbers according to claim 13, wherein the diene is ethylidene norbornene.

17. Blend of rubbers according to claim 13, wherein rubber c) is hydrogenated nitrile butadiene rubber having a backbone with a saturation level between 90 and 95%.

18. Blend of rubbers according to claim 13, wherein rubber c) comprises a (halogenated) butyl rubber or a (halogenated) isobutylene/para-alkylstyrene copolymer.

19. Blend of rubbers according to claim 13, wherein rubber c) is pre-vulcanized with a sulfur vulcanization system comprising an accelerator selected from a benzothiazole sulfenamide or a benzothiazole sulfenimide.

20. Process for the preparation of a vulcanized blend of rubbers, wherein a blend according to claim 13 is co-vulcanized.

21. Vulcanized blend of rubbers, prepared in a process according to claim 1.

22. Tire, comprising a vulcanized blend according to claim 21.

23. Blend, vulcanized blend, or tire according to claim 1, wherein rubber c) is an ethylene/propylene/diene rubber.
